(19) United States
(12) Patent Application Publication
(10) Pub. No.: US 2026/0320143 A1
(43) Pub. Date: Oct. 15, 2026

(54) COMPUTER-IMPLEMENTED METHODS OF RESPONDING TO A USER TRAVEL SEARCH QUERY

(71) Applicant: SKYSCANNER TECHNOLOGY LIMITED, London (GB)

(72) Inventor: Andrew EACOTT, London (GB)

(21) Appl. No.: 19/483,300

(22) PCT Filed: Mar. 8, 2024
(86) PCT No.: PCT/GB2024/050635

§ 371 Date: Nov. 11, 2025

(30) Foreign Application Priority Data
May 11, 2023 (GB) 2307008.9

(51) Int. Cl. G06F 16/9537; G06F 16/9535

(52) U.S. Cl. CPC G06F 16/9537; G06F 16/9535

(57) ABSTRACT

A method of responding to a user travel search query, comprising: (i) a back end for front end (BFF) sends a BFF travel search query to a Unified Search Service (USS), starting a search at an initial geo-type level in a geographical hierarchy; (ii) the USS selecting backends according to the geo-type level; (iii) the USS calling the selected backends in relation to the BFF query, and receiving any search results sets from the selected backends, and any updates to the BFF query; (iv) including in a USS response set the received search result sets; (v) updating the BFF travel search query; (vi) repeating steps (ii) to (v), including lowering a depth of a searched geo-type level in the geographical hierarchy, until no backends remain to be queried, or until the geo-type level reaches the specified geo-type target resolution; (vii) the USS applying a reduction algorithm on the USS response set to produce a reduced USS response set; (viii) the USS returning the reduced USS response set to the BFF.

### BACKGROUND OF THE INVENTION

### 1. Field of the Invention

The field of the invention relates to computer-implemented methods of responding to a user travel search query, which may be a general travel search query, and to related systems and servers.

### 2. Technical Background

Internet travel search services are in ever-greater demand, which means that internet travel search services are consuming ever more energy. Individual travel searches tend to take some time, which means that users' searching activities can be constrained by the time the users have available to search. When including a new travel search service aspect in an existing travel search service, e.g. pandemic travel restrictions, travel deals, it can be cumbersome to integrate a new travel search service aspect into an existing travel search service, e.g. because of incompatible data structures.

Accordingly, there is a need for a way to reduce the energy consumed by internet travel services, while maintaining the level of the search services provided, or while improving the level of the search services provided. There is also a need for a way to integrate a new travel search service aspect into an existing travel search service more easily.

### 3. Discussion of Related Art

U.S. Pat. No. 11,030,635B2 discloses a computer server receives a request for a price for goods or services, such as airfares, together with parameters defining those goods or services, for example: activity type, such as airfare, hotel booking, train fare; date range; destination; origin; desired weather conditions; star ratings; keywords; any other user defined preference. One or more processors programmed with software then infer, estimate or predict estimated prices from an incomplete historical price dataset by analysing patterns in that dataset and provide the price estimates to an end-user computing device, such as a personal computer, smartphone or tablet.

U.S. Pat. No. 11,294,912B2 discloses a computer-implemented method of providing a set of alternative search results, the method including the steps of:
(i) receiving a search request;
(ii) searching a database to provide a first set of a plurality of search results, each search result including a plurality of attributes;
(iii) identifying a best search result as the initially highlighted result;
(iv) providing the highlighted search result for display;
(v) receiving a selection of an attribute in the highlighted search result;
(vi) providing the set of alternative search results, in which the selected attribute is varied with respect to the highlighted search result, and
(vii) providing the set of alternative search results for display.

### SUMMARY OF THE INVENTION

According to a first aspect of the invention, there is provided a computer-implemented method of responding to a user travel search query, which may be a general travel search query, the method including the steps of:
(i) a back end for front end (BFF) receiving the user travel search query;
(ii) the BFF processing the user travel search query to define a BFF travel search query, the BFF travel search query including (a) an origin, (b) an inventory list type, (c) a specified geo-type target resolution for one or more destinations, (d) a query boundary including a geo-type defining the one or more destinations, (e) a date scope, and (f) filtering criteria;
(iii) the BFF sending the BFF travel search query to a Unified Search Service (USS), the USS starting a search at an initial geo-type level in a geographical hierarchy;
(iv) the USS selecting backends according to the geo-type level in the geographical hierarchy, and according to the date scope;
(v) the USS calling the selected backends in relation to the BFF travel search query, and receiving any search results sets from the selected backends, and any updates to the BFF travel search query;
(vi) including in a USS response set the received search result sets;
(vii) updating the BFF travel search query using any received updates to the BFF travel search query;
(viii) repeating steps (iv) to (vii), including lowering a depth of a searched geo-type level in the geographical hierarchy, until no backends remain to be queried, or until the geo-type level reaches the specified geo-type target resolution;
(ix) the USS applying a reduction algorithm on the USS response set, using the filtering criteria, to produce a reduced USS response set;
(x) the USS returning the reduced USS response set to the BFF;
(xi) the BFF processing the reduced USS response set to produce a processed reduced USS response set, and responding to the user travel search query using the processed reduced USS response set.

An advantage is that the method uses less energy than when a user makes many specific search requests, which occurs when the user is trying to obtain more general travel search results than can be obtained from a specific search request. An advantage is that a user obtains search results more quickly than when a user makes many specific search requests, which occurs when the user is trying to obtain more general travel search results than can be obtained from a specific search request, because making many search requests takes longer than making a single general travel search request. An advantage is that it is easy to include a new backend, because the general query grammar supports including a new backend easily. An advantage is the method provides an improvement in computer technology.

The method may be one in which a query grammar for BFF travel search queries is: “With Origin (ORIGIN), show results of type (INVENTORY_LIST) at (TARGET_RESOLUTION) resolution for destination(s) (QUERY_BOUNDARY) filtered by (FILTER_LIST) for dates (DATE_SCOPE)”. Advantages are that the method is low energy, fast and it is easy to include a new backend.

The method may be one in which the data type geo-type identifies a depth in the (e.g. Skyscanner) Geographical Hierarchy e.g. ANYWHERE, COUNTRY, CITY, PLACE. Advantages are that the method is low energy, fast and it is easy to include a new backend.

The method may be one wherein the filtering criteria include a data type FILTER_LIST which is a List of Trip Modifier constraints to be applied by USS backends; this contains a filter type enumeration, optionally plus parameters. Advantages are that the method is low energy, fast and it is easy to include a new backend.

The method may be one wherein the filtering criteria include a filter list of a data type TRIP_MODIFIER which defines query filters: enumerated constraints used to restrict results returned from USS. Advantages are that the method is low energy, fast and it is easy to include a new backend.

The method may be one wherein the constraints are evaluated by one or more of the USS backends orchestrated by the USS service itself. e.g. Travel Restrictions may be set as LOW or MODERATE.

The method may be one in which the date scope identifies a date scope of ANYTIME, or MONTH(s), or DATE(s).

The method may be one in which the date scope includes flexible departure dates.

The method may be one in which the date scope includes flexible duration of the trip. The method may be one in which the origin identifies an origin location for the traveller, with a Travel Entity ID and a geo-type, eg. CITY (<<EntityId>>).

The method may be one in which the inventory list type is a List of Search Inventory type enumerations, e.g. Search backend identifiers. Advantages are that the method is low energy, fast and it is easy to include a new backend.

The method may be one in which the geo-type target resolution defines the query's target scope: the geographical resolution required for results, e.g. COUNTRY, or CITY, or AIRPORT. Advantages are that the method is low energy, fast and it is easy to include a new backend.

The method may be one in which the query boundary defines a query starting scope, defining a boundary for the recommendations and suggestions query space, e.g. I am looking at ANYWHERE destinations, or I am looking at this list of six CITIES. Advantages are that the method is low energy, fast and it is easy to include a new backend.

The method may be one in which the date scope is defined by a DATE_RESOLUTION identifier (e.g. ANYTIME, SEASON, MONTH etc) and optionally parameters.

The method may be one in which the date scope identifies a resolution and parameters. The method may be one in which the USS suggests, ranks and retrieves search inventory for travellers.

The method may be one in which the Unified Search Service (USS) is configured to perform ‘Normal’ searches, and in which the USS is configured to perform ‘Advanced’ searches.

The method may be one in which the BFF request specifies a ‘Geo Scope’, which is a ‘root node(s)’ in the geographical hierarchy. Advantages are that the method is low energy, fast and it is easy to include a new backend.

The method may be one in which the USS coordinates a process to traverse the geographical hierarchy from the root node using suggestion and filtering logic selected by the client. Advantages are that the method is low energy, fast and it is easy to include a new backend.

The method may be one in which the USS uses data provided by other services in the search domain to coordinate the process to traverse the geographical hierarchy from the root node using suggestion and filtering logic selected by the client. Advantages are that the method is low energy, fast and it is easy to include a new backend.

The method may be one in which a search starts at root node(s) in the hierarchy and ends when nodes at a specified depth in the hierarchy have been identified and returned to the client. Advantages are that the method is low energy, fast and it is easy to include a new backend.

The method may be one in which the BFF is in communication with the USS via an interface, e.g. an interface using gRPC/HTTP (e.g. protobuf).

The method may be one in which the USS is in communication with search backends (e.g. for flights, for hotels, for vehicle hire) via an interface, e.g. an interface using gRPC/HTTP (e.g. protobuf).

The method may be one in which for each interface there is provided a corresponding inventory schema.

The method may be one in which a common inventory schema is used for the interfaces.

The method may be one in which the common inventory schema uses protobuf.

The method may be one in which a user does not need to integrate with multiple backends individually. Advantages are that the method is low energy, fast and it is easy to include a new backend.

The method may be one in which a user needs to specify their query only once. Advantages are that the method is low energy, fast and it is easy to include a new backend.

The method may be one in which USS search backends implement server-side filtering.

The method may be one in which filter constraints are expressed in the USS backend interface and are implemented by all participating ‘Advanced’ search backends.

The method may be one in which a (e.g. BFF) component outside of USS identifies entity IDs e.g. visible in a map (based on zoom level), in order to populate the USS request.

The method may be one in which in the event that a dependency is not available, the search fails fast and uses fallback data sources to approximate an ‘Advanced’ search result.

The method may be one in which the USS uses a static, in-memory alternative list of suggested locations if it is unable to retrieve personalized recommended locations within a predetermined time frame.

The method may be one in which the method includes a refinement process including: Generating suggested locations; Filtering and/or ranking suggestions; Dispatching queries to ‘Advanced’ search backends for data related to these locations, and Aggregating and returning results.

The method may be one in which the USS uses a destination suggestion backend to generate possible destinations based on a requested Geo Scope and filters.

The method may be one in which the suggestions are returned from the backend as a list of Entity IDs that meet the query criteria.

The method may be one in which the USS dispatches this list of entity IDs to other backends along with backend filtering criteria; and the results returned from these backends contain a new list of Entity IDs that match only the specified backend filter criteria. Advantages are that the method is low energy, fast and it is easy to include a new backend.

The method may be one in which the USS queries any remaining backends to retrieve outstanding results for the filtered entity IDs.

The method may be one in which during a refinement process, the USS forms a dynamic pipeline, which defines in which order the backends are called.

The method may be one in which backends called first are used to refine, suggest and/or filter the provided query into a more specific one, e.g. transform the initial geo scope of anywhere to a list of countries safe to travel to.

The method may be one in which the performance of the pipeline is defined by a priority of the components in the pipeline.

The method may be one in which the USS determines the order to query the backends using the provided filters in the explore query.

The method may be one in which when a query contains a recommendation request, the USS asks a “destination suggester” backend to get recommendations.

The method may be one in which the USS imposes a limit on the number of entities included in the BFF request.

The method may be one in which the USS imposes a limit of the number of entities included in a request to a backend service.

The method may be one in which in order to satisfy a client-facing request, the USS makes more than one request to a USS backend in order to stay within the limit.

The method may be one in which the USS truncates the list of suggested destinations after applying prioritization and ranking.

The method may be one in which the BFF handles mapping USS SearchResult schema elements (backend-specific) to front-end needs.

The method may be one in which the BFF translates between map coordinates and travel entity IDs.

The method may be one in which the BFF includes enrichment logic to return text copy, or images, or videos or other content about destinations.

The method may be one in which the USS includes ranking of the results set of returned inventory.

The method may be one in which the USS includes combining the results of multiple backends into a single response. Advantages are that the method is low energy, fast and it is easy to include a new backend.

The method may be one in which the search backends provide a schema for the inventory type.

The method may be one in which a search backend applies a query model, such as server-side filtering.

The method may be one in which the USS server implementation itself is stateless and includes no caching of results.

The method may be one in which the USS Backends implement their own caching strategies.

The method may be one in which the BFF provides to the user a map interface, and the BFF receives a selection of where the user wants to go to, as the destination(s).

The method may be one in which the map interface shows travel restrictions & destination safety information.

The method may be one in which backends queried include Travel Restrictions, Destination Safety.

The method may be one in which backends queried include Travel Restrictions, Advanced Flights, Destination Safety, Deals.

The method may be one in which a map is shown to the user with personalized recommended destinations.

The method may be one in which Backends queried include Travel Restrictions, Advanced Flights, Destination Safety, Deals, Destination Recommender(s).

The method may be one in which a map is shown to the user with hotel indicative pricing or with trips pricing.

The method may be one in which the USS processes as input Shorthand names for geographical groupings, such as “the Alps”, “the Riviera”.

The method may be one in which search backends return refined intent which contains the requested geo entities as provided in the destination set of the original intent, or the next level in geo scope hierarchy.

The method may be one in which search backends return an origin which is either the requested origin or an updated origin used by the backend to answer the request.

The method may be one in which if the request does not define travel dates (i.e. date resolution is ANYTIME), backends can use this field to recommend the travel dates or simply provide the default value they used when searching the results.

The method may be one in which available geo informs USS, which geo entities the backend was able to return.

The method may be one in which the USS backends include Advanced Flights, e.g. in which queries include one or more of: ANYWHERE request returning data for all countries from origin city with date range; or COUNTRY list request returning data for selected countries from origin city with date range; or CITY list request returning data for selected cities from origin city with date range.

The method may be one in which the USS backends include Destination Recommender, e.g. in which queries include one or more of: City-level—Generates personalized recommendations of cities similar to an entered destination entity ID (city)—Parameters UTID, Origin Entity ID, Origin Country Code (Market), Destination Entity ID; Country-level-Generates personalized recommendations for countries similar to entered destination entity ID (country)—Parameters UTID, Origin Country Code (Market), Destination Entity ID (Country).

The method may be one in which in backend querying: BFF constructs and sends Search Intent to USS (501); Travel Restrictions sends an unfiltered response containing: List of country entity IDs; Travel restrictions data per country ID, as USS backend result (502); USS Extracts list of matching destinations from Travel Restrictions response (503); optionally Ranks/truncates matching destinations list to keep within query constraints; Dispatches a new Search Intent containing list of destinations to remaining search backend (Destination Safety); USS constructs a client response message containing Result payloads from Travel Restrictions and Destination Safety (504); and a List of matching destinations as entity IDs; USS returns result to BFF (505). Advantages are that the method is low energy, fast and it is easy to include a new backend.

The method may be one in which the USS includes location entities with Geo coordinates in results.

The method may be one in which the USS includes appending geo information to requested and returned entity IDs.

The method may be one in which the USS is written in Java and deployed in Cells.

The method may be one including the step of storing the processed reduced USS response set, or storing the reduced USS response set.

Advantages are that the method is low energy, fast and it is easy to include a new backend.

According to a second aspect of the invention, there is provided a system including a BFF server, a USS server and backend servers, the system configured to perform a method of any aspect according to a first aspect of the invention.

According to a third aspect of the invention, there is provided a computer-implemented method of responding to a user travel search query, which may be a general travel search query, including the steps of:
(i) a BFF sends a BFF travel search query to a Unified Search Service (USS), the USS starting a search at an initial geo-type level in a geographical hierarchy;
(ii) the USS selecting backends according to the geo-type level in the geographical hierarchy, and according to the date scope;
(iii) the USS calling the selected backends in relation to the BFF travel search query, and receiving any search results sets from the selected backends, and any updates to the BFF travel search query;
(iv) including in a USS response set the received search result sets;
(v) updating the BFF travel search query using any received updates to the BFF travel search query;
(vi) repeating steps (ii) to (v), including lowering a depth of a searched geo-type level in the geographical hierarchy, until no backends remain to be queried, or until the geo-type level reaches the specified geo-type target resolution;
(vii) the USS applying a reduction algorithm on the USS response set, using the filtering criteria, to produce a reduced USS response set;
(viii) the USS returning the reduced USS response set to the BFF. Advantages are that the method is low energy, fast and it is easy to include a new backend.

The method may be one including a method of any aspect of the first aspect of the invention.

According to a fourth aspect of the invention, there is provided a system including a BFF server, a USS server and backend servers, the system configured to perform a method of any aspect of the third aspect of the invention.

According to a fifth aspect of the invention, there is provided a computer-implemented method of responding to a user travel search query, which may be a general travel search query, including a USS lowering a depth of a searched geo-type level in a geographical hierarchy, until no backends remain to be queried, or until the geo-type level reaches a specified geo-type target resolution. Advantages are that the method is low energy, fast and it is easy to include a new backend.

The method may be one including a method of any aspect of the first aspect of the invention.

According to a sixth aspect of the invention, there is provided a system including a USS server and backend servers, the system configured to perform a method of any aspect of the fifth aspect of the invention.

According to a seventh aspect of the invention, there is provided a system including a BFF server and a USS server, the USS server in communication with backend servers, the system configured to respond to a user travel search query, which may be a general travel search query, in which:
(i) the back end for front end (BFF) server is configured to receive the user travel search query;
(ii) the BFF server is configured to process the user travel search query to define a BFF travel search query, the BFF travel search query including (a) an origin, (b) an inventory list type, (c) a specified geo-type target resolution for one or more destinations, (d) a query boundary including a geo-type defining the one or more destinations, (e) a date scope, and (f) filtering criteria;
(iii) the BFF server is configured to send the BFF travel search query to a Unified Search Service (USS) server, the USS server configured to start a search at an initial geo-type level in a geographical hierarchy;
(iv) the USS server is configured to select backends according to the geo-type level in the geographical hierarchy, and according to the date scope;
(v) the USS server is configured to call the selected backends in relation to the BFF travel search query, and to receive any search results sets from the selected backends, and any updates to the BFF travel search query;
(vi) the USS server is configured to include in a USS response set the received search result sets;
(vii) the USS server is configured to update the BFF travel search query using any received updates to the BFF travel search query;
(viii) the USS server is configured to repeat (iv) to (vii), including lowering a depth of a searched geo-type level in the geographical hierarchy, until no backends remain to be queried, or until the geo-type level reaches the specified geo-type target resolution;
(ix) the USS server is configured to apply a reduction algorithm on the USS response set, using the filtering criteria, to produce a reduced USS response set;
(x) the USS server is configured to return the reduced USS response set to the BFF server;
(xi) the BFF server is configured to process the reduced USS response set to produce a processed reduced USS response set, and to respond to the user travel search query using the processed reduced USS response set.

An advantage is that the system uses less energy than when a user makes many specific search requests, which occurs when the user is trying to obtain more general travel search results than can be obtained from a specific search request. An advantage is that a user obtains search results more quickly than when a user makes many specific search requests, which occurs when the user is trying to obtain more general travel search results than can be obtained from a specific search request, because making many search requests takes longer than making a single general travel search request. An advantage is that it is easy to include a new backend, because the general query grammar supports including a new backend easily. An advantage is the system provides an improvement in computer technology.

The system may be configured to perform a method of any aspect of the first aspect of the invention.

According to an eighth aspect of the invention, there is provided a BFF server of any aspect of the seventh aspect of the invention.

According to a ninth aspect of the invention, there is provided a USS server of any aspect of the seventh aspect of the invention.

According to a tenth aspect of the invention, there is provided a system including a BFF server and a USS server, the USS server in communication with backend servers, the system configured to respond to a user travel search query, which may be a general travel search query, in which:
(i) the BFF server is configured to send a BFF travel search query to the Unified Search Service (USS) server, the USS server configured to start a search at an initial geo-type level in a geographical hierarchy;
(ii) the USS server configured to select backends according to the geo-type level in the geographical hierarchy, and according to the date scope;
(iii) the USS server configured to call the selected backends in relation to the BFF travel search query, and to receive any search results sets from the selected backends, and any updates to the BFF travel search query;
(iv) the USS server is configured to include in a USS response set the received search result sets;
(v) the USS server is configured to update the BFF travel search query using any received updates to the BFF travel search query;
(vi) the USS server is configured to repeat (ii) to (v), including lowering a depth of a searched geo-type level in the geographical hierarchy, until no backends remain to be queried, or until the geo-type level reaches the specified geo-type target resolution;
(vii) the USS server is configured to apply a reduction algorithm on the USS response set, using the filtering criteria, to produce a reduced USS response set;
(viii) the USS server is configured to return the reduced USS response set to the BFF server.

An advantage is that the system uses less energy than when a user makes many specific search requests, which occurs when the user is trying to obtain more general travel search results than can be obtained from a specific search request. An advantage is that a user obtains search results more quickly than when a user makes many specific search requests, which occurs when the user is trying to obtain more general travel search results than can be obtained from a specific search request, because making many search requests takes longer than making a single general travel search request. An advantage is that it is easy to include a new backend, because the general query grammar supports including a new backend easily. An advantage is the system provides an improvement in computer technology.

The system may be configured to perform a method of any aspect of the first aspect of the invention.

According to an eleventh aspect of the invention, there is provided a BFF server of any aspect of the tenth aspect of the invention.

According to a twelfth aspect of the invention, there is provided a USS server of any aspect of the tenth aspect of the invention.

According to a thirteenth aspect of the invention, there is provided a Unified Search Service (USS) server, the USS server in communication with backend servers, the USS server configured to call selected backend servers in relation to a travel search query received from a BFF server, in relation to responding to a user travel search query, which may be a general travel search query, in which the USS server is configured to lower a depth of a searched geo-type level in a geographical hierarchy, until no backends remain to be queried, or until the geo-type level reaches a specified geo-type target resolution.

An advantage is that the USS server uses less energy than when a user makes many specific search requests, which occurs when the user is trying to obtain more general travel search results than can be obtained from a specific search request. An advantage is that a user obtains search results more quickly than when a user makes many specific search requests, which occurs when the user is trying to obtain more general travel search results than can be obtained from a specific search request, because making many search requests takes longer than making a single general travel search request. An advantage is that it is easy to include a new backend, because the general query grammar supports including a new backend easily. An advantage is the USS server provides an improvement in computer technology.

The USS server may be configured to perform a method of any aspect of the first aspect of the invention.

Aspects of the invention may be combined.

### BRIEF DESCRIPTION OF THE FIGURES

Aspects of the invention will now be described, by way of example(s), with reference to the following Figures, in which:

FIG. 1 shows an example in which a Unified Search Service (USS) can perform ‘Normal’ searches, and in which the USS may also perform ‘Advanced’ searches.

FIG. 2 shows an example in which a search starts at root node(s) in the hierarchy and ends when nodes at a specified depth in the tree have been identified and returned to the client.

FIG. 3 shows an example in which a search at the top left accesses more content, and more inventory is created as the process progresses from the top left to the bottom right. Specificity increases from left to right and from top to bottom. PSS is passenger service system. PDP is policy decision point.

FIG. 4 shows an example of a USS Intent Refinement Algorithm.

FIG. 5 shows an example of backend querying.

FIG. 6 shows an example of backend querying.

### DETAILED DESCRIPTION

A travel-related search service (e.g. Skyscanner's) may contain a wealth of information published from many services, each using a bespoke application programming interface (API) and query model. Due to this diversity, it may be time consuming and complex to access and combine search inventory data for different use cases. As a result, there may be too much use case-specific computer program code along with associated maintenance overhead.

A Unified Search Service may address this problem. A Unified Search Service (USS) may act as a gateway to a (e.g. Skyscanner's) search domain and may provide a single API with a domain-agnostic query grammar offering Combined Results for highly-specific ‘Normal’ queries (e.g. with a known origin, destination and travel dates), and for more general ‘Advanced’ queries.

In an initiative, we introduce the ability to respond to a different class of search queries, ‘Advanced’ queries, with more scope for receiving an original query which is something matching the traveller's intent. USS and participating search backends may be configured in order to support this different class of ‘Advanced’ search queries.

We may provide a ‘unified API’ approach while also standardising query models for inventory backends so that onboarding additional data sources and filter criteria takes less effort and can deliver value to travellers more quickly.

A goal for this Unified Search Service (USS) is to present users with destination options that meet their criteria and budget. An additional goal is to build a common framework to support future search ‘Advanced’ search use cases without extensive rework.

### Example Design Aspects

A production-scale solution suitable for an initial use case of displaying flight prices and travel restrictions e,g, on a map, e.g. filtered by safety.
Defined APIs for client and backend USS ‘Advanced’ search components.
Defined standard query model and non-functional requirements for USS ‘Advanced’ search components.
Build suitable abstractions within USS to enable future iteration on ‘Advanced’ search queries without significant changes for other components.
Fully generic USS ‘Advanced’ search support (e.g. allowing arbitrary filtering and data sources).

### Overview and Theory of Operation

### A Unified Search Service (USS) Architecture

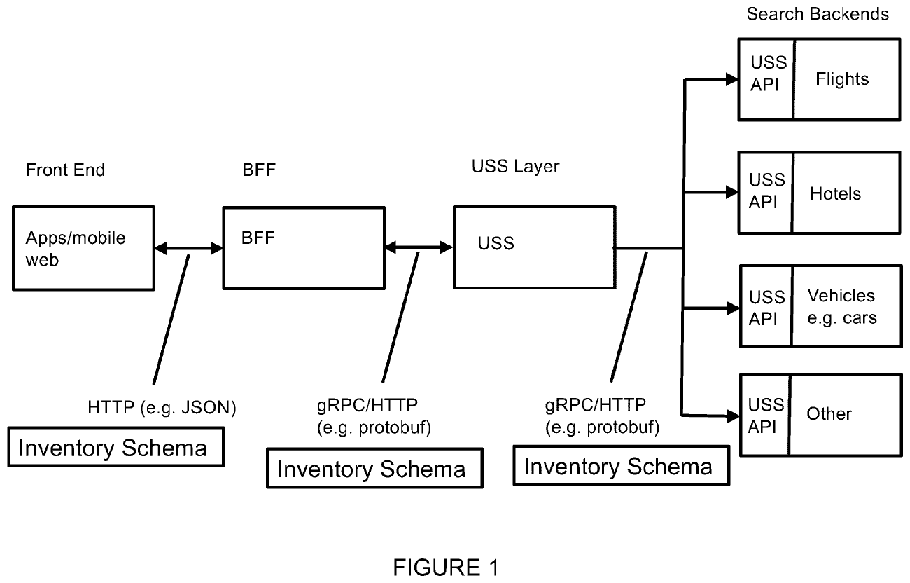

In an example, the USS supports Combined Results via Normal-style search queries. The traveller query is captured as specific parameters in a single ‘intent’ request sent to USS. The query is dispatched to multiple search inventory providers (“backends”) with results aggregated together by USS. See FIG. 1, for example. A search backend may wrap an inventory schema to a USS search backend response. The USS may collect results from all search backends and wrap them in a USS schema.

In an example, a front end is in communication with a back end for front end (BFF) via a web interface. The BFF is in communication with a USS layer via an interface, e.g. an interface using gRPC/HTTP (e.g. protobuf). The USS layer is in communication with search backends (e.g. for flights, for hotels, for vehicle hire) via an interface, e.g. an interface using gRPC/HTTP (e.g. protobuf). For each interface there is provided a corresponding inventory schema. See FIG. 1, for example.

There are a number of benefits with this approach:
Clients of the search domain do not need to integrate with multiple backends individually
Clients need specify their query only once
New search backends/inventory can be exposed to clients relatively quickly since the USS backend interaction is well-defined and shared by all backends
Concentrating all queries through USS affords a single place to apply processing for cross-cutting concerns (e.g. in future) (e.g. relevance ranking or event logging)

In an example, a common schema has been defined for the client-facing request/response API along with a separate API implemented by USS backends. The common schema may use Protocol Buffers (Protobuf), which is a cross-platform data format used to serialize structured data. Search backends should be compatible with being USS backends. gRPC calls may be possible between the back end for front end (BFF) server and the USS layer, where gRPC (gRPC Remote Procedure Calls) is a cross-platform high performance remote procedure call (RPC) framework. gRPC calls may be possible between the USS layer and the search backends.

Example backends in USS: Flights; Hotels; Car Hire; Deals (a Deals Engine).

### Design Principles

The following section lists the principles incorporated into the design:
‘Normal’ query types and ‘Advanced’ (sometimes referred to as “Explore”) query types require different performance characteristics from USS components:

| | | | Specificity | | |
|---|---|---|---|---|---|
| Search | Type of | Non-functional | in Request/ | | |
| Type | Intent | Requirements | Response | Polling? | Examples |
| Normal | High | Can take time to | High. | Optional | Flights |
| | | deliver accurate | Fixed time/ | | search. |
| | | and exhaustive | date (within | | Hotels |
| | | results. Low | small time | | search. |
| | | response time is | range) and | | |
| | | not as important | fixed | | |
| | | as accuracy. | locations, | | |
| | | | User | | |
| | | | Specified | | |
| Advanced | Low | Low response time | Low. | Not | Advanced |
| (Explore) | | is critical, | No or low | necessary. | Flights |
| | | indicative results | specificity | | search. |
| | | are acceptable => | for date | | Trips |
| | | Availability is | ranges | | pricing. |
| | | critical, if optimal | and locations | | Deals |
| | | results are not | | | search. |
| | | available, any | | | Travel |
| | | suitable results | | | Restrictions. |
| | | are preferable to | | | |
| | | none. | | | |

USS ‘Advanced’ search queries will typically generate more results at the requested geo hierarchy depth than are required by the client (e.g. more cities than could be displayed on a map). As such, USS search backends may implement some level of server-side filtering. Filter constraints may be expressed in the USS backend interface and should be implemented by all participating ‘Advanced’ search backends.

For example, a Travel Restrictions API may support queries relating to [ANYWHERE, COUNTRY];

An Advanced Flights API may support queries relating to [ANYWHERE, COUNTRY, CITY];

A Travel Restrictions API query may return results for a list of N COUNTRIES (expressed as a list of travel entity IDs).

This ensures all clients can make requests and interpret results using the same geographical grammar. This implies a component outside of USS should be responsible for identifying entity IDs e.g. visible in a map (based on zoom level), in order to populate the USS request.

For example, a list of (e.g. Skyscanner) Travel Entity IDs is provided for the countries (e.g. visible in a map viewport) as the query start nodes. Although ‘Advanced’ search queries may commonly require ‘refinement’, suggestions and filtering to determine results to be returned, this may not always be the case.

USS may also able to provide results from ‘Normal’ search backends where the client already knows precisely which locations they wish to retrieve. For example, a search using, schematically, “given this list of cities, retrieve INDICATIVE_PRICES and TRAVEL_RESTRICTIONS data with no filters”: the USS query model may support this type of query.

By the nature of ‘Advanced’ searches, the traveller does not know precisely what results they can expect to see. Although it is intended to return optimised and relevant results if possible, the design should also strive to avoid hard dependencies that could result in the search query failing.

In the event that a dependency is not available, the search should fail fast and use fallback data sources to approximate an ‘Advanced’ search result. The client may be able to gracefully handle a degraded ‘Advanced’ search response where results from a requested backend is not available.

For example, USS should delegate to a reliable/static/in-memory alternative list of suggested locations if it is unable to retrieve personalized recommended locations within a reasonable time frame.

Stable abstractions and interfaces between USS and external components are provided. Provided we have sufficiently isolated components using these abstractions, a fully generic refinement algorithm capable of supporting future ‘Advanced’ search and ‘Normal’ search use cases can follow iteratively.

USS Combined ‘Advanced’ and ‘Normal’ searches Concept

The Combined ‘Advanced’ and ‘Normal’ searches experience is implicitly linked with the concept of a Geographical Hierarchy.

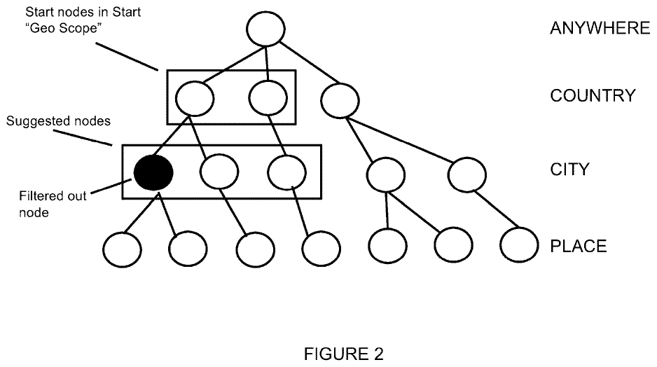

Any given search starts at root node(s) in the hierarchy and ends when nodes at a specified depth in the tree have been identified and returned to the client. An example is shown in FIG. 2.

USS may coordinate a process to traverse the geo hierarchy from the root node using suggestion and filtering logic selected by the client. USS may use data provided by other services in the search domain to achieve this (e.g. some combination of Price, Safety, Relevance, Theme etc).

In other words, USS delivers value for ‘Advanced’ and ‘Normal’ searches by suggesting, ranking and retrieving search inventory for travellers.

When received from a client, many ‘Advanced’-style search queries lack specificity and need to be refined into more concrete queries before they can be sent to the backends holding search inventory.

To generalise, we can think of an example of the refinement process as using USS backends and user intent to:
1) Generate suggested locations
2) Filter and/or rank suggestions
3) Dispatch queries to ‘Advanced’ search backends for data related to these locations
4) Aggregate and return results.

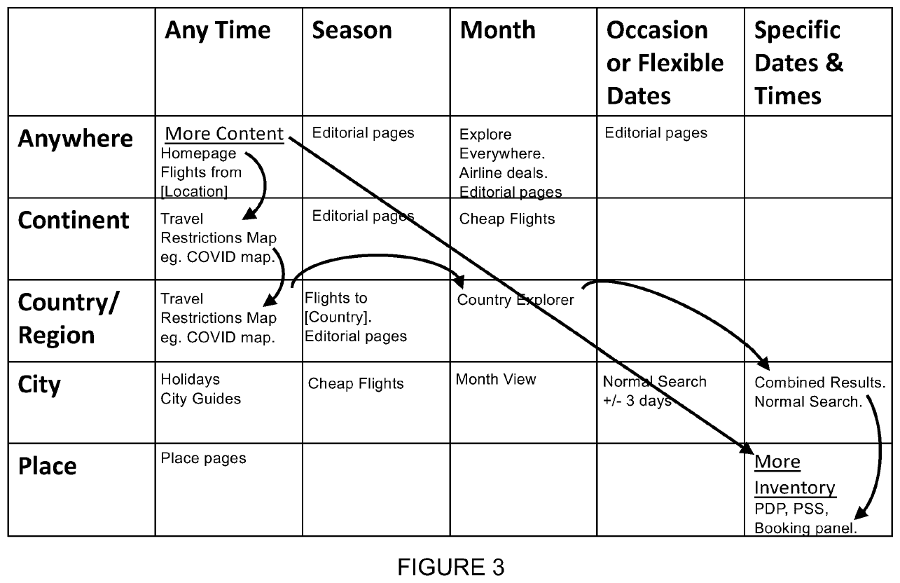

A travel-related search may progress from a homepage, in which a continent is selected, then a country or region is selected, then a search in a country for a given month is requested and performed, which yields specific dates and times for possible city destinations. Following selection of a specific city, a ‘Normal’ search is performed, which leads to a selection of a specific trip, and hence to a booking panel. An example is shown in FIG. 3. In FIG. 3, the searches at the top left access more content, and more inventory is created as the process progresses from the top left to the bottom right.

### Query Model

An example query grammar for USS ‘Advanced’ search queries is:

“With Origin (ORIGIN), show results of type (INVENTORY_LIST) at (TARGET_RESOLUTION) resolution for destination(s) (QUERY_BOUNDARY) filtered by (FILTER_LIST) for dates (DATE_SCOPE)”

In an example, there is a data type GEO_TYPE which identifies a ‘depth’ in the (e.g. Skyscanner) Geo Hierarchy e.g. ANYWHERE, COUNTRY, CITY, PLACE.

In an example, there is a data type GEO_SCOPE, which includes a GEO_TYPE plus an optional list of (e.g. Skyscanner) Travel Entity IDs which identify node(s) in the (e.g. Skyscanner) Geo Hierarchy e.g. CITY <<1234>>.

In an example, there is a data type FILTER_LIST which is a List of Trip Modifier constraints to be applied by USS backends. This contains a filter type enumeration plus optional parameters.

In an example, there is a data type DATE_SCOPE which identifies a date scope (e.g, ANYTIME, MONTH(s), DATE(s)).

In an example, there is a query parameter ORIGIN of the data type SINGLE_GEO_SCOPE which identifies the origin location for the traveller, with a Travel Entity ID and a GEO_TYPE. In an example, CITY (<<EntityId>>) is supported.

In an example, there is a query parameter INVENTORY_LIST of the data type SEARCH_INVENTORY_TYPE, in which there is a List of Search Inventory type enumerations, e.g. Search backend identifiers.

In an example, there is a query parameter TARGET_RESOLUTION of the data type GEO_TYPE which defines the query's target scope: the geographical resolution required for results, e.g. COUNTRY, or CITY, or AIRPORT.

In an example, there is a query parameter QUERY_BOUNDARY of the data type GEO_SCOPE which defines a query starting scope: this defines the boundary for the recommendations and suggestions query space, e.g. I am looking at ANYWHERE destinations, or I am looking at this list of 6 CITIES.

In an example, there is a query parameter FILTER_LIST of the data type TRIP_MODIFIER which defines query filters: enumerated constraints used to restrict results returned from USS. These constraints are evaluated by one or more of the USS backends orchestrated by the USS service itself. e.g. Travel Restrictions may be set as LOW or MODERATE.

In an example, there is a query parameter DATE_SCOPE of the data type DATE_SCOPE which may be defined by a DATE_RESOLUTION identifier (e.g. ANYTIME, SEASON, MONTH etc) and optional parameters.

An example ‘Advanced’ search query, which is a very general one, is:

“With origin (CITY<<LONDON>>), show results of type
(TRAVEL_RESTRICTIONS, FLIGHTS_INDICATIVE_PRICING, DEALS) at
(COUNTRY<<*>>) resolution for destination(s) (ANYWHERE<<*>>) filtered by
(TRAVEL_RESTRICTIONS == LOW) for dates (ANYTIME<<*>>)”

### USS Intent Refinement Algorithm

The USS “Advanced” search query processor may operate as follows:
1. A client request specifies a ‘Geo Scope’ (‘root node(s)’ in the geo hierarchy) as well as a
desired ‘Geo Resolution’ for results. Additionally, a client request includes a ‘Date Range’ identifying a resolution and parameters (e.g. ANYTIME, MONTH, DAYS), e.g. “I am considering [COUNTRY(1,2,3,4)] and would like [CITY] resolution for results filtered by ‘MODERATE’ Travel Safety” for ‘MONTH(2,3)’; or
“I am considering [ANYWHERE] and would like [CITY] resolution for results filtered by ‘Beach’” for ‘ANYTIME’.
2. USS uses a destination suggestion backend to generate possible destinations based on the requested Geo Scope and filters. These suggestions are returned from the backend as a list of Entity IDs that could meet the query criteria.
3. USS dispatches this list of entity IDs to other backends along with filtering criteria. Results returned from these backends contain a new list of Entity IDs that match only the specified filter criteria.
4. USS applies a reduction algorithm on returned entity IDs from all backend results to determine a single list of entity IDs matching all requested ranking criteria.
5. USS queries any remaining backends to retrieve outstanding results for the filtered entity IDs.

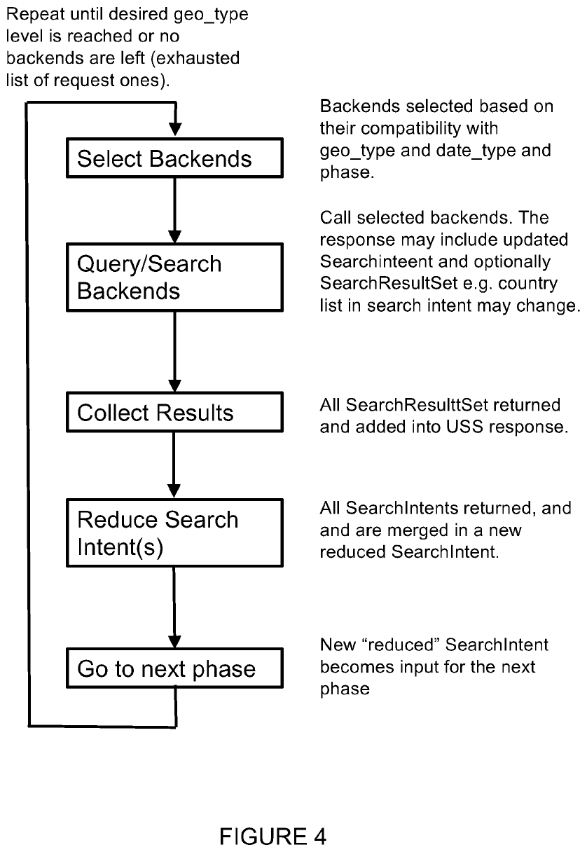

FIG. 4 shows an example of a USS Intent Refinement Algorithm.

### Backend Prioritisation

During a refinement process, a USS may form a dynamic pipeline, which defines in which order the backends are called. Typically, the backends called first are used to refine, suggest and/or filter the provided query into a more specific one, e.g. transform the initial geo scope of anywhere to a list of countries safe to travel to.

In the rest of the pipeline, backends provide results to a more specific query and have an option to further refine the query for the remaining steps in the pipeline. This also means the performance of the pipeline is defined by the priority of the components in it. It is a responsibility of the USS to determine the best order based on the provided filters in the explore query.

When a query contains a recommendation request, such as “cheapest destinations” or “beach holiday”, the USS may ask a “destination suggester” backend to get recommendations in the first step. This could be followed by the TravelRestrictions backend that filters destinations with “low” restrictions in the second step and then the rest of the backends in parallel in the last iteration. However, if the recommendation filter was not provided, the first step would be skipped and the initial set of country suggestions would be provided by the TravelRestrictions backend, before continuing the rest of the backends as in the first scenario.

A dedicated “destination suggester” component providing travel recommendations based on the “destination themes” may be provided. The TravelRestrictions backend may fulfill the role of “suggester,” in an example.

### Query Limits

It is clear that the refinement process is likely to generate many more suggested destinations than will efficiently fit in a single query to a USS backend (or which can be shown to clients).

This imposes a number of requirements:
a) USS may impose a limit on the number of entities included in a client API request. For example, it would not be reasonable for a BFF to send a single USS request asking for indicative flights results for 500 cities. The actual limit is determined during implementation but the client may send more than one request if more results are needed.
b) USS may similarly impose a limit of the number of entities included in a request to a backend service. The actual limit is determined during implementation, but it is typically in the low 10's of entities per request. In order to satisfy a client-facing request, USS may make more than one request to a USS backend in order to stay within this limit.
c) An example of the ‘Advanced’ search refinement algorithm may adopt a strategy of truncating the list of suggested destinations after applying prioritization and ranking, in order to keep the number of results manageable for downstream USS components.

### USS Component Responsibilities

The BFF may handle communication with USS, including constructing search intent, and error handling, retries, etc. The BFF may handle mapping USS SearchResult schema elements (backend-specific) to front-end needs. The BFF may translate between map coordinates and travel entity IDs. The BFF may assume responsibility for: Deriving a list of visible country/cities as entity IDs e.g. given a map viewport and zoom level; Deriving geo coordinates for entity IDs returned in USS results. The USS may instead assume this responsibility in an alternative example.

In an example, the USS may not return text copy/images/videos or other content about destinations, as these may be supplied by dedicated backends. As such, BFFs may need to take on some enrichment logic if there is a product need to return text copy/images/videos or other content about destinations.

The USS may include validation and enrichment of the search intent. The USS may include intent refinement: orchestrating other search backends regarding deadlines propagation to the downstream services, and/or error handling, and/or resilience on backend failures. The USS may include ranking of the results sets of returned inventory. The USS may include combining the results of multiple backends into a single response.

The search backends may provide a schema for the inventory type. The search backends may apply a query model, such as server-side filtering. The search backends may conform to service-level objectives (SLOs).

### USS Component Non-Functional Requirements and SLOs

Performance and Availability for an ‘Advance’ search experience is important. In an example, we aim to deliver USS Explore SLOs as follows: <600 ms response time; 99.9% aggregate availability.

Since USS relies on orchestrating other data sources to deliver results, in an example it is important that other ‘Advanced’ search components conform to strict SLOs: e.g. <200 ms response time; 99.9% aggregate availability; USS API calls fully instrumented with OpenTelemetry tracing.

For the USS Response Time, an assumption may be that USS requires sequential calls to at most two backends for query refinement, followed by one request to remaining backends for data retrieval, hence three times the backend response time.

In order to mitigate the availability impact of multiple dependencies, the USS implementation attempts to: Limit the complexity of filtering/suggestion/retrieval logic to a maximum number of sequential steps (where an algorithm ‘step’ is one or more concurrent calls to an external service to gather suggestions or filtered results); Enforce deadlines for dependencies and apply sensible fallback policies if deadlines are exceeded; Return a degraded result if not all inventory is available (e.g. omit some result types, and then return what has been successfully retrieved).

In an example, the USS server implementation itself is stateless and includes no caching of results. In an example, the USS Explore Backends are responsible for implementing their own caching strategies, if used. In an example, session stickiness is not supported.

### Example Interface: A “where can I Go?” Map, with Prices

We describe example supported queries. All queries start with a CITY origin.

An example query requests to show a map with travel restrictions & destination safety information. Example Backends involved include Travel Restrictions, Destination Safety. The destination may be ANYWHERE. There is no filter.

An example query requests to show a map with travel restrictions, flights prices & deals for COUNTRIES (a list) with X travel restrictions and a DATE RANGE. Example Backends involved include Travel Restrictions, Advanced Flights, Destination Safety, Deals. The destination may be COUNTRY [<<entity_id_list>>]. A filter may be Travel Restrictions==Low, or Moderate, or High.

An example query requests to show a map with travel restrictions, flights prices & deals for CITIES (a list) with X travel restrictions and a DATE_RANGE. Example Backends involved include Travel Restrictions, Advanced Flights, Destination Safety, Deals. The destination may be CITY [<<entity_id_list>>]. A filter may be Travel Restrictions==Low, or Moderate, or High.

An example query requests to show a map with personalized recommended destinations. Example Backends involved include Travel Restrictions, Advanced Flights, Destination Safety, Deals, Destination Recommender(s).

An example query requests to show a map with hotel indicative pricing. An example query requests to show a map with trips pricing.

### POSSIBLE EXAMPLES

The USS can process any type of query that can be resolved, by USS or one of its data sources, into a list of travel entity IDs. Examples: using as input Map Viewport (a Latitude and Longitude box). Using as input Shorthand names for geographical groupings, such as “the Alps”, “the Riviera”.

The USS can process a request for enriched entity data for suggested results, such as geographic coordinates for rendering in a map component.

The USS can enable ranking of results with models in a generic way, e.g using a Relevance Service backend.

### USS Client API

The same API is provided for ‘Normal’ searches and for ‘Advanced’ searches. In the ‘Advanced’ search requests, clients may send a new ExploreIntent with less specific geographic destination and travel dates compared to a ‘Normal’ search. In an example, clients are expected to send geo type for all entities. USS may proceed even if not all results are available: in an example, a response may include travel restrictions data but omit indicative flights pricing even if both were requested. In an example, clients may indicate if a particular type of inventory is mandatory.

An example normal search client request is:

service UnifiedSearchService {
rpc CreateSearch (CreateSearchRequest) returns (CreateSearchResponse) {
//Initiate a search
}
rpc PollSearch (PollSearchRequest) returns (PollSearchResponse) {
//Poll for updates on an existing search
}
}
message CreateSearchRequest {
RequestContext request_context = 1;
SearchIntent intent = 2;
}
message PollSearchRequest {
RequestContext request_context = 1;
// Session token. Callers must set this to be the latest ′session_token′
// that has been received in a ′SearchResponse′ for this particular session.
string session_token = 2;
}
message CreateSearchResponse {
SearchIntent search_intent = 1; //Search intent including any enrichment of the
original user-supplied parameters
SearchResponse search_response = 2;
}
message PollSearchResponse {
SearchResponse search_response = 1;
}
message SearchIntent {
TravellerContext traveller_context = 1;
repeated TripElement trip_element = 2;
}
message TripElement {
parameter1; //Specific location (entity ID)
parameter2;
parameter3; //Specific date
parameter4;
parameter5; //Used to pass modifiers from the client to be interpreted by intent
processors (e.g. cabin_class == ″business″ )
}
For an example ‘Advanced’ search request use-case, clients are expected to send an
‘Advanced’ (″explore″) intent to USS. Backwards compatibility with a ‘normal’
search use-case may be preserved by using “oneof”. In an example, the USS does not
support combination of a ‘Normal’ search intent and an ‘Advanced’ search intent in a
single client request. An example ‘Advanced’ search client request is:
message
CreateSearchRequest {
RequestContext
request_context = 1;
oneof search_intent {
SearchIntent intent = 2;
ExploreIntent
explore_intent = 3;
}
}

In the “‘Advanced’ search (explore) intent”, clients can define:
destination—non-specific travel destinations as broad as “anywhere” or more specific ones, as a combination of geo type and entity IDs, which could be for example a list of countries or cities to be included in ‘Advanced’ (explore) search.
travel_date—flexible departure dates and duration of the trip
desired geo_resolution—used to determine the desired level of geo specificity of the results, e.g. a client can use the field to tell USS it only wants COUNTRY level to be returned, so USS won't attempt to look for backends dealing with cities or airports.
modifiers—define the filters to be applied during the search, for example a travel restriction filter: e.g. TRIP_MODIFIER_TRAVEL_RESTRICTIONS=6; TRIP_MODIFIER_CONSTRAINT_EQUALS_TO=LOW. An example ‘Advanced’ search client request is:

// Explore intent can be used instead of SearchIntent when requesting
// results for flexible destinations and/or travel dates
message ExploreIntent {
TravellerContext
traveller_context = 1;
// Starting point of the trip
Geo origin = 2;
// Desired travel destinations, this can be as wide as anywhere,
// or more restricted by the type of entity and entity IDs
MultiGeo destination = 3;
// Desired type of geo entities to be returned by USS
GeoType
desired_geo_resolution = 4;
// Travel dates, inc. flexible departure dates
TravelDate travel_date = 5;
// Filters to be applied on the search request
repeated TripModifier
modifier = 6;
}

Geo and MultiGeo may be used to represent one or more geo locations specified by their entity IDs and corresponding geo type. The following geo types may be supported: ANYWHERE; COUNTRY; CITY; AIRPORT.

Date resolution may be used to define the specificity of the provided travel date. For example:
ANYTIME—travel date doesn't matter
MONTH—flexibility of the travel dates within a specific month, may be used in combination with flexible_dates.month_of_year.
RANGE—departure dates for the travel need to be within a specific range defined by flexible_dates.departure_date.
SPECIFIC—departure dates are fixed, i.e. from and to dates are given and provided in specific_dates.

An example ‘Advanced’ search client request is:

message Geo {
// Canonical geo ′type′ describing the type of the provided
// entity, e.g. country, city, airport
GeoType type = 1;
// Entity ID of the place, or empty when type is GEO_TYPE_ANYWHERE
string entity_id = 2;
}
// MutiGeo type is used to represent multiple geo entities of the same type
message MultiGeo {
GeoType type = 1;
// Entity IDs of places, or empty when type is GEO_TYPE_ANYWHERE
repeated string
entity_id = 2;
}
message TravelDate {
DateResolution
resolution = 1;
oneof travel_date {
FlexibleDates
flexible_dates = 2;
DateRange
specific_dates = 3;
}
}
// Canonical geo ′type′ describing the type of the provided
// entities, e.g. country, city, airport
enum GeoType {
GEO_TYPE_UNSPECIFIED = 0;
GEO_TYPE_ANYWHERE = 1;
GEO_TYPE_COUNTRY = 2;
GEO_TYPE_CITY = 3;
GEO_TYPE_AIRPORT = 4;
}
enum DateResolution {
DATE_RESOLUTION_UNSPECIFIED = 0;
DATE_RESOLUTION_ANYTIME = 1;
DATE_RESOLUTION_RANGE = 2;
DATE_RESOLUTION_MONTH = 3;
DATE_RESOLUTION_SPECIFIC = 4;
}
message TravelDate {
DateResolution
resolution = 1;
oneof travel_date {
FlexibleDates
flexible_dates = 2;
DateRange
specific_dates = 3;
}
}
// Flexible dates can be used when traveller does
// not know the exact travel dates
message FlexibleDates {
oneof departure {
// Specifies the earliest from and latest to dates as a range
DateRange
departure_date = 1;
// Month of a year.
Must be from 1 to 12,
// or 0 to specify the depart range is being used
int32 month_of_year = 2;
}
// Desired duration of the trip in days, or 0 if not relevant
int32 duration_in_days = 3;
}
message DateRange {
LocalDate from = 1;
LocalDate to = 2;
}
USS ‘Advanced’ search (Explore) Backend API

‘Advanced’ search (Explore) backends may use a different Backend remote procedure call (RPC) API compared to ‘Normal’ search backends; this allows a clear separation for implementation and observability purposes.

Responses from both RPC APIs allows a backend to return:
a set of results served by the given backend
a more refined version of the original intent, which can be used to traverse to the next level in the geo hierarchy (if supported by the given backend).

Search backends might support polling, but in an example it is not supported by the USS clients for ‘Normal’ search and ‘Advanced’ search.

USS backends may implement both RPC services but may return an empty result if they do not wish to provide ‘Normal’ search or ‘Advanced’ search results.

‘Normal’ search and ‘Advanced’ search use cases may use the “new” explore intent that is less specific than the SearchIntent, which is used for searching the exact travel destinations and dates.

There may be cases where a search backend is used to provide both ‘Normal’ search and ‘Advanced’ search results (e.g. Travel Restrictions). In this case, the backend should implement both RPC services. Example remote procedure calls (RPCs) for ‘Normal’ search requests are:

//Existing RPC for Day View queries
service SearchBackendService {
rpc CreateBackendSearch
(CreateBackendSearchRequest)
returns
(CreateBackendSearchResponse) {
//Create search in backend
}
rpc PollBackendSearch
(PollBackendSearchRequest) returns
(PollBackendSearchResponse) {
//Poll for updates on an existing search in this backend
}
}
message CreateBackendSearchRequest {
RequestContext request_context = 1;
SearchIntent search_intent = 2;
}
//New RPC for Explore queries
service ExploreSearchBackendService
{
rpc
CreateExploreBackendSearch
(CreateExploreBackendSearchRequest)
returns
(CreateExploreBackendSearchResponse)
{
//Create Explore search in backend
}
}
message
CreateExploreBackendSearchRequest {
RequestContext request_context = 1;
ExploreIntent explore_intent = 2;
}

Along with the search results (if any), search backends return the refined intent. Refined intent contains the requested geo entities as provided in the destination set of the original intent, or the next level in geo scope hierarchy.
origin is either the requested origin from the explore intent or an updated origin used by the backend to answer the request, e.g. origin can be London (City) in the request, but the search backend translates it to London Heathrow (Airport).
available geo informs USS, which geo entities the backend was able to return; this can be used in multiple ways:
   when backend wants to recommend/filter the list of geo entities from the request, e.g. country entities 1,2,3,4,5 where provided in the request, but only 1,3,5 satisfy the filter of being safe to travel to, so the available geo in the response intent may only include those;
   when backend is able to traverse to the lower level of geo hierarchy, e.g. request asks for geo scope ANYWHERE, and backend is able to return a list of recommended COUNTRY level entities;
travel date represents a concrete or flexible range of dates when to travel:
   if the request does not define travel dates (i.e. date resolution is ANYTIME), backends can use this field to recommend the travel dates or simply provide the default value they used when searching the results;
   if the request defines more specific travel date (e.g. a specific month or a range of departure dates), the backends are expected to return the same value. Example backend search responses are:

message BackendSearchResponse {
//Gives information for the status of the request and if it requires more polling to be
fully fetched.
SessionState session_state = 1;
oneof results_wrapper {
SearchResultSet result_set = 2;
google.protobuf.Any
opaque_result = 3;
}
//If action == REPLACED, prior results in the session are no longer valid
//If action != REPLACED, prior results still stand
ResultAction action = 4;
// Updated intent that is being responded by the backend
RefinedExploreIntent intent = 5;
}
message RefinedExploreIntent {
// Explore backends can alter the origin to more specific
Geo origin = 1;
// Returned/Suggested Geo results
MultiGeo available_geo = 2; //Returned/Suggested Geo results
// Suggested travel dates
TravelDate travel_date = 3;
}

### Example USS Backends

An example USS backend is Travel Restrictions. Example query models for ‘Normal’ search are: Origin entity ID is mandatory (Country or City); Single destination entity ID is optional—if not set, data for all countries is returned; Results keyed by Country as a travel entity ID; NOT date aware. Example queries for ‘Advanced’ search are: ANYWHERE request returning data for all countries from origin city; COUNTRY list request returning data for selected countries; Filtered ANYWHERE list request returning data for all countries where restrictions==(LOW or MODERATE or HIGH); Filtered COUNTRY list request returning data for selected countries where restrictions==(LOW or MODERATE or HIGH).

An example USS backend is Destination Safety. Example query models for ‘Normal’ search are: No query parameters-all data returned on each request; Results keyed by Country as a travel entity ID; NOT date aware; HTTP only. Example queries for ‘Advanced’ search are: ANYWHERE request returning data for all countries; COUNTRY list request returning data for selected countries.

An example USS backend is Advanced Flights. Example query models for ‘Normal’ search are: Lookup into pre-prepared datasets supporting a variety of data access patterns include day/month/anytime. Example queries for ‘Advanced’ search are: ANYWHERE request returning data for all countries from origin city with date range; COUNTRY list request returning data for selected countries from origin city with date range; CITY list request returning data for selected cities from origin city with date range. Here, DateRange may be expressed as one of ANYTIME, YYMMDD range or Month(s).

An example USS backend is Deals. Example query models for ‘Normal’ search are: Origin entity ID as CITY or AIRPORT; List of destination entity IDs is optional (AIRPORT/CITY/COUNTRY); FromDate(Y/M/D) ToDate(Y/M/D); Optional limit on number of returned results. Example queries for ‘Advanced’ search are: ANYWHERE request returning N deals for all destinations from origin city with date range; COUNTRY list returning N deals for selected countries and date range. Here, DateRange may be expressed as one of ANYTIME, YYMMDD range or Month(s).

An example USS backend is Destination Recommender. Example query models for ‘Normal’ search are: City-level-Generates personalized recommendations of cities similar to an entered destination entity ID (city)—Parameters UTID, Origin Entity ID, Origin Country Code (Market), Destination Entity ID; Country-level-Generates personalized recommendations for countries similar to entered destination entity ID (country)—Parameters UTID, Origin Country Code (Market), Destination Entity ID (Country).

Worked Examples are:

request_context {
inventory {
inventory_type: SEARCH_INVENTORY_TYPE_DESTINATION_SAFETY
}
inventory {
inventory_type: SEARCH_INVENTORY_TYPE_TRAVEL_RESTRICTIONS
}
}
explore_intent {
origin {
type: GEO_TYPE_CITY
entity_id: “27544008”
}
destination {
type: GEO_TYPE_ANYWHERE
}
desired_geo_resolution: GEO_TYPE_COUNTRY
}

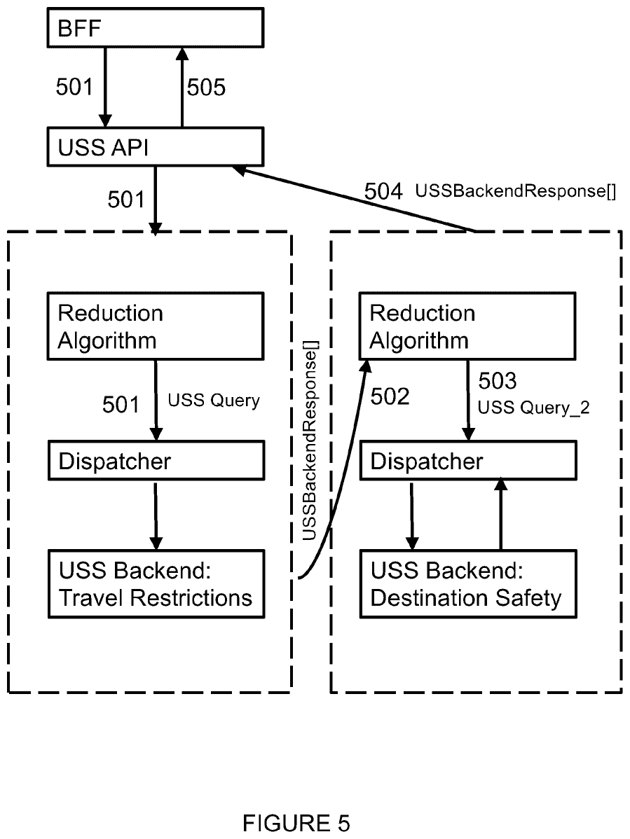

In an example of backend querying, in step 501, BFF constructs and sends Search Intent to USS. Intent contains LONDON ‘ANYWHERE’ as the query geo scope. In step 502, Travel Restrictions sends an unfiltered response containing: List of country entity IDs; Travel restrictions data per country ID, as USS backend result. In step 503, USS Extracts list of matching destinations from Travel Restrictions response; optionally Ranks/truncates matching destinations list to keep within query constraints; Dispatches a new Search Intent containing list of destinations to remaining search backend (Destination Safety). In step 504, USS constructs a client response message containing Result payloads from Travel Restrictions and Destination Safety; and a List of matching destinations as entity IDs. In step 505, USS returns result to BFF. An example is shown in FIG. 5. An example search request is:

request_context {
inventory {
inventory_type: SEARCH_INVENTORY_TYPE_TRAVEL_RESTRICTIONS
}
inventory {
inventory_type: SEARCH_INVENTORY_TYPE_DEALS
}
inventory {
inventory_type: SEARCH_INVENTORY_TYPE_FLIGHTS_INDICATIVE
}
}
explore_intent {
origin {
type: GEO_TYPE_CITY
entity_id: “27544008”
}
destination {
type: GEO_TYPE_COUNTRY
entity_id: “1”
entity_id: “2”
entity_id: “3”
entity_id: “4”
}
desired_geo_resolution: GEO_TYPE_COUNTRY
travel_date {
resolution: DATE_RESOLUTION_MONTH
flexible_dates {
month_of_year: 5
}
}
modifier {
modifier_type: TRIP_MODIFIER_TYPE_TRAVEL_RESTRICTIONS_LOW
}
}

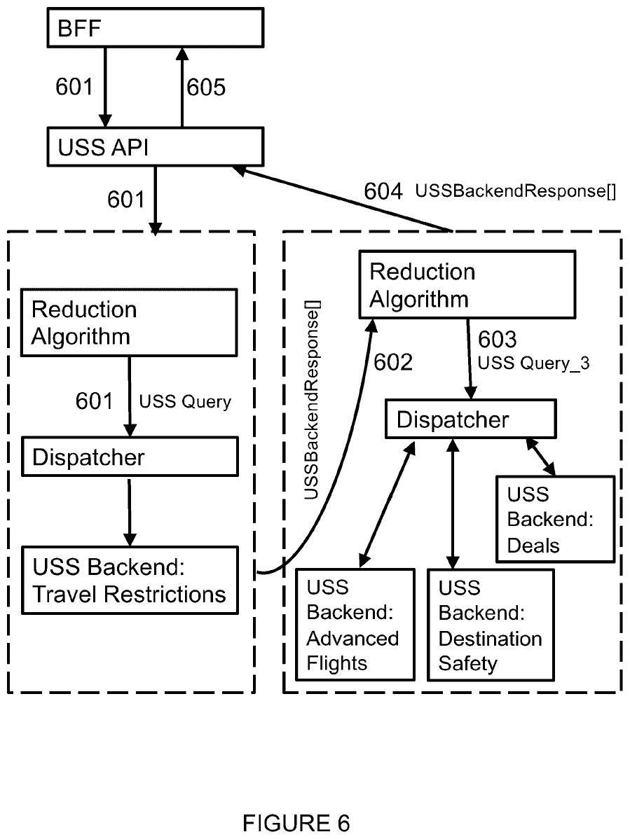

In an example of backend querying, in step 601, BFF constructs and sends Search Intent to USS. Intent contains LONDON ‘COUNTRY [1,2,3,4]’ as the query geo scope. In step 602, based on geo scope and filter parameters in the Search Intent, USS determines that Travel Restrictions should be used to generate suggested destinations by applying filter parameters. The Search Intent is dispatched to the Travel Restrictions USS Backend. Travel Restrictions returns a USS Backend Response containing: List of destinations (country entity IDs) matching filter parameters; Travel Restrictions data for each matching country. In step 603, USS Extracts list of matching destinations from Travel Restrictions response; optionally Ranks/truncates matching destinations list to keep within query constraints; Dispatches a new Search Intent containing list of destinations to remaining search backends (Advanced Flights Search, Destination Safety and Deals). In step 604, USS constructs a client response message containing Result payloads from Travel Restrictions, Advanced Flights Search, Destination Safety and Deals; and a List of matching destinations as entity IDs. In step 605, USS returns result to BFF. An example is shown in FIG. 6. An example search request is:

request_context {
inventory {
inventory_type: SEARCH_INVENTORY_TYPE_TRAVEL_RESTRICTIONS
}
inventory {
inventory_type: SEARCH_INVENTORY_TYPE_DEALS
}
inventory {
inventory_type: SEARCH_INVENTORY_TYPE_FLIGHTS_INDICATIVE
}
}
explore_intent {
origin {
type: GEO_TYPE_CITY
entity_id: “27544008”
}
destination {
type: GEO_TYPE_CITY
entity_id: “111”
entity_id: “222”
entity_id: “333”
entity_id: “444”
}
desired_geo_resolution: GEO_TYPE_CITY
travel_date {
resolution: DATE_RESOLUTION_RANGE
flexible_dates {
departure_date {
from {
year: 2021
month: 4
day: 10
}
to {
year: 2021
month: 5
day: 10
}
}
}
}
modifier {
modifier_type: TRIP_MODIFIER_TYPE_TRAVEL_RESTRICTIONS_LOW
}
}

In an example of backend querying, in step 701, BFF constructs and sends Search Intent to USS. Intent contains LONDON ‘CITY [111,222,333,444]’ as the query geo scope. Intent contains CITY as the target geo scope to be returned as results. In step 702, based on geo scope and filter parameters in the Search Intent, USS determines that Travel Restrictions should be used to suggest country destinations by applying the provided trip modifier (i.e. TRIP_MODIFIER_TYPE_TRAVEL_RESTRICTIONS_LOW). Here, Travel Restrictions requires COUNTRY level input. In step 703, USS calls “common geo API” to get the list of countries: “common geo API” responds with: the list of countries associated with the cities provided in the original request. In step 704, the updated Search Intent (with the entities of COUNTRY level) is dispatched to the Travel Restrictions USS Backend. Travel Restrictions returns a USS Backend Response containing: List of destinations (country entity IDs) matching the provided filter; Travel Restrictions data for each matching country. In step 705, USS Extracts list of matching CITY destinations from Travel Restrictions response; Optionally Ranks/truncates matching destinations list to keep within query constraints; Dispatches a new Search Intent containing list of destinations to remaining search backends: Advanced Flights-returns city level indicative flights prices for the destination countries as results; Destination Safety-returns destination restrictions for the set of destination countries; Deals-returns deals to the set of destination countries. In step 706, USS constructs a client response message containing: Result payloads from Travel Restrictions, Advanced Flights, Destination Safety and DEALS; List of matching destinations as entity IDs. In step 707, USS returns result to BFF.

### Common Geo API

Geo entity data is an important element of the ‘Normal’ search and ‘Advanced’ search solution.

The following geo related use cases have been identified for USS ‘Advanced’ components:
Advanced Flights requires translation of geo entity IDs to route node IDs used internally to create the required cache keys;
In an example, BFF/USS client layer needs to map the viewport coordinates to a list of visible entity IDs;
In an example, BFF/USS client needs to map from entity IDs into places on the map using geo coordinates, which are readily available in geo entity data;
Given any entity ID with a country, retrieve country ID;
Retrieve airport child nodes for a given entity ID.

These queries are supported by the Travel API, which can be accessed directly or through a convenient Travel API java client.

In an example, the USS does not integrate with geo service itself. Instead, the USS client and backends perform the desired mapping suitable for their purpose. In an example, geo enrichment is provided as an optional feature of the USS API, e.g. adding geo data to entity IDs returned from an ‘Advanced’ search query.

### Other Features

Some scenarios require ‘Advanced’ search results with different geo resolution. (e.g. Show map prices for cities in USA but country-level prices for adjacent Caribbean countries). How may the USS query model support this? This is handled by making multiple requests to USS with different geo scoped queries. This results in extra calls to USS but is still reasonably efficient.

The USS may enrich location entities with Geo coordinates in results. This saves the client/BFF from extra work. USS may include an enrichment function to append geo information to requested and returned entity IDs.

Use USS to expose indicative prices and other information for non-traveller queries (e.g. Provide a Search engine optimization (SEO) page with indicative pricing or point of interest (POI) data for a destination or airline route). If the query includes the correct starting and target geo scopes, the refinement algorithm should carry this out. For example, Query Scope=CITY (12335); Target Scope=CITY; InventoryTypes=Advanced Flights, TRAVEL_RESTRICTIONS.

### Language and Frameworks

In an example, the USS Service is written in Java and deployed in Cells. In an example, the client-facing API contract supports both Protobuf-over-HTTP and gRPC (gRPC is preferred); USS backend integrations support both Protobuf-over-HTTP and gRPC (HTTP is supported, gRPC is implemented in this design and is the preferred integration approach for backends deployed in Cells).

### NOTE

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred example(s) of the invention, it will be apparent to those of ordinary skill in the art that numerous modifications can be made without departing from the principles and concepts of the invention as set forth herein.

1. A computer-implemented method of responding to a user travel search query, which may be a general travel search query, the method including the steps of:
(i) a back end for front end (BFF) receiving the user travel search query;
(ii) the BFF processing the user travel search query to define a BFF travel search query, the BFF travel search query including (a) an origin, (b) an inventory list type, (c) a specified geo-type target resolution for one or more destinations, (d) a query boundary including a geo-type defining the one or more destinations, (e) a date scope, and (f) filtering criteria;
(iii) the BFF sending the BFF travel search query to a Unified Search Service (USS), the USS starting a search at an initial geo-type level in a geographical hierarchy;
(iv) the USS selecting backends according to the geo-type level in the geographical hierarchy, and according to the date scope;
(v) the USS calling the selected backends in relation to the BFF travel search query, and receiving any search results sets from the selected backends, and any updates to the BFF travel search query;
(vi) including in a USS response set the received search result sets;
(vii) updating the BFF travel search query using any received updates to the BFF travel search query;
(viii) repeating steps (iv) to (vii), including lowering a depth of a searched geo-type level in the geographical hierarchy, until no backends remain to be queried, or until the geo-type level reaches the specified geo-type target resolution;
(ix) the USS applying a reduction algorithm on the USS response set, using the filtering criteria, to produce a reduced USS response set;
(x) the USS returning the reduced USS response set to the BFF;
(xi) the BFF processing the reduced USS response set to produce a processed reduced USS response set, and responding to the user travel search query using the processed reduced USS response set.

2. The method of claim 1, in which a query grammar for BFF travel search queries is: “With Origin (ORIGIN), show results of type (INVENTORY_LIST) at (TARGET_RESOLUTION) resolution for destination(s) (QUERY_BOUNDARY) filtered by (FILTER_LIST) for dates (DATE_SCOPE)”.

3. The method of claim 1, in which the data type geo-type identifies a depth in the (e.g. Skyscanner) Geographical Hierarchy e.g. ANYWHERE, COUNTRY, CITY, PLACE.

4. (canceled)

5. The method of claim 1, wherein the filtering criteria include a filter list of a data type TRIP_MODIFIER which defines query filters: enumerated constraints used to restrict results returned from USS.

6. The method of claim 5, wherein the constraints are evaluated by one or more of the USS backends orchestrated by the USS service itself. e.g. Travel Restrictions may be set as LOW or MODERATE.

7. The method of claim 1, in which the date scope identifies a date scope of ANYTIME, or MONTH(s), or DATE(s).

8-9. (canceled)

10. The method of claim 1, in which the origin identifies an origin location for the traveller, with a Travel Entity ID and a geo-type, eg. CITY (<<EntityId>>).

11. The method of claim 1, in which the inventory list type is a List of Search Inventory type enumerations, e.g. Search backend identifiers.

12. The method of claim 1, in which the geo-type target resolution defines the query's target scope: the geographical resolution required for results, e.g. COUNTRY, or CITY, or AIRPORT.

13. The method of claim 1, in which the query boundary defines a query starting scope, defining a boundary for the recommendations and suggestions query space, e.g. I am looking at ANYWHERE destinations, or I am looking at this list of six CITIES.

14. The method of claim 1, in which the date scope is defined by a DATE_RESOLUTION identifier (e.g. ANYTIME, SEASON, MONTH etc) and optionally parameters.

15-16. (canceled)

17. The method of claim 1, in which the Unified Search Service (USS) is configured to perform ‘Normal’ searches, and in which the USS is configured to perform ‘Advanced’ searches.

18. The method of claim 1, in which the BFF request specifies a ‘Geo Scope’, which is a ‘root node(s)’ in the geographical hierarchy.

19. The method of claim 1, in which the USS coordinates a process to traverse the geographical hierarchy from the root node using suggestion and filtering logic selected by the client.

20. The method of claim 19, in which the USS uses data provided by other services in the search domain to coordinate the process to traverse the geographical hierarchy from the root node using suggestion and filtering logic selected by the client.

21. The method of claim 1, in which a search starts at root node(s) in the hierarchy and ends when nodes at a specified depth in the hierarchy have been identified and returned to the client.

22. The method of claim 1, in which the BFF is in communication with the USS via an interface, e.g. an interface using gRPC/HTTP (e.g. protobuf).

23. The method of claim 1, in which the USS is in communication with search backends (e.g. for flights, for hotels, for vehicle hire) via an interface, e.g. an interface using gRPC/HTTP (e.g. protobuf).

24. (canceled)

25. The method of claim 22 or 23, in which a common inventory schema is used for the interfaces.

26-27. (canceled)

28. The method of claim 1, in which a user needs to specify their query only once.

29-33. (canceled)

34. The method of claim 1, in which the method includes a refinement process including: Generating suggested locations; Filtering and/or ranking suggestions; Dispatching queries to ‘Advanced’ search backends for data related to these locations, and Aggregating and returning results.

35. The method of claim 1, in which the USS uses a destination suggestion backend to generate possible destinations based on a requested Geo Scope and filters.

36-38. (canceled)

39. The method of claim 1, in which during a refinement process, the USS forms a dynamic pipeline, which defines in which order the backends are called.

40. The method of claim 39, in which backends called first are used to refine, suggest and/or filter the provided query into a more specific one, e.g. transform the initial geo scope of anywhere to a list of countries safe to travel to.

41. (canceled)

42. The method of claim 1, in which the USS determines the order to query the backends using the provided filters in the explore query.

43-44. (canceled)

45. The method of claim 1, in which the USS imposes a limit of the number of entities included in a request to a backend service.

46-82. (canceled)

83. A system including a BFF server and a USS server, the USS server in communication with backend servers, the system configured to respond to a user travel search query, which may be a general travel search query, in which:
(i) the back end for front end (BFF) server is configured to receive the user travel search query;
(ii) the BFF server is configured to process the user travel search query to define a BFF travel search query, the BFF travel search query including (a) an origin, (b) an inventory list type, (c) a specified geo-type target resolution for one or more destinations, (d) a query boundary including a geo-type defining the one or more destinations, (e) a date scope, and (f) filtering criteria;
(iii) the BFF server is configured to send the BFF travel search query to the Unified Search Service (USS) server, the USS server configured to start a search at an initial geo-type level in a geographical hierarchy;
(iv) the USS server is configured to select backends according to the geo-type level in the geographical hierarchy, and according to the date scope;
(v) the USS server is configured to call the selected backends in relation to the BFF travel search query, and to receive any search results sets from the selected backends, and any updates to the BFF travel search query;
(vi) the USS server is configured to include in a USS response set the received search result sets;
(vii) the USS server is configured to update the BFF travel search query using any received updates to the BFF travel search query;
(viii) the USS server is configured to repeat (iv) to (vii), including lowering a depth of a searched geo-type level in the geographical hierarchy, until no backends remain to be queried, or until the geo-type level reaches the specified geo-type target resolution;
(ix) the USS server is configured to apply a reduction algorithm on the USS response set, using the filtering criteria, to produce a reduced USS response set;
(x) the USS server is configured to return the reduced USS response set to the BFF server;
(xi) the BFF server is configured to process the reduced USS response set to produce a processed reduced USS response set, and to respond to the user travel search query using the processed reduced USS response set.

84-85. (canceled)

86. A USS server forming part of a system including a BFF server and the USS server, the USS server in communication with backend servers, the system configured to respond to a user travel search query, which may be a general travel search query, in which:
(i) the back end for front end (BFF) server is configured to receive the user travel search query;
(ii) the BFF server is configured to process the user travel search query to define a BFF travel search query, the BFF travel search query including (a) an origin, (b) an inventory list type, (c) a specified geo-type target resolution for one or more destinations, (d) a query boundary including a geo-type defining the one or more destinations, (e) a date scope, and (f) filtering criteria;
(iii) the BFF server is configured to send the BFF travel search query to the Unified Search Service (USS) server, the USS server configured to start a search at an initial geo-type level in a geographical hierarchy;
(iv) the USS server is configured to select backends according to the geo-type level in the geographical hierarchy, and according to the date scope;
(v) the USS server is configured to call the selected backends in relation to the BFF travel search query, and to receive any search results sets from the selected backends, and any updates to the BFF travel search query;
(vi) the USS server is configured to include in a USS response set the received search result sets;
(vii) the USS server is configured to update the BFF travel search query using any received updates to the BFF travel search query;
(viii) the USS server is configured to repeat (iv) to (vii), including lowering a depth of a searched geo-type level in the geographical hierarchy, until no backends remain to be queried, or until the geo-type level reaches the specified geo-type target resolution;
(ix) the USS server is configured to apply a reduction algorithm on the USS response set, using the filtering criteria, to produce a reduced USS response set;
(x) the USS server is configured to return the reduced USS response set to the BFF server;
(xi) the BFF server is configured to process the reduced USS response set to produce a processed reduced USS response set, and to respond to the user travel search query using the processed reduced USS response set.

87-92. (canceled)
